(19) United States
(12) Patent Application Publication
(10) Pub. No.: US 2026/0092821 A1
(43) Pub. Date: Apr. 2, 2026

(54) POUCH CELL BATTERY COMPRESSION AMPOULE FOR A CALORIMETER

(71) Applicant: TA Instruments-Waters LLC, New Castle, DE (US)

(72) Inventors: Joshua Reinholdt Bladh, Provo, UT (US); Donald J. Russell, Mapleton, UT (US)

(21) Appl. No.: 19/341,149

(22) Filed: Sep. 26, 2025

Related U.S. Application Data
(60) Provisional application No. 63/700,245, filed on Sep. 27, 2024.

(51) Int. Cl. G01K 17/00; H01M 10/42; H01M 50/105

(52) U.S. Cl. CPC G01K 17/00; H01M 10/4285; H01M 50/105

(57) ABSTRACT

A calorimeter lifting tool for holding a pouch cell battery within a calorimeter includes a base including a first pressure surface, a pressure plate including a second pressure surface, the pressure plate attachable to the base such that the first pressure surface of the base and the second pressure surface of the pressure plate define a space between which a pouch cell battery having a first cell surface and an opposing second cell surface is configured be held such that a first pressure surface of the base applies pressure to the first cell surface of the pouch cell battery and the second pressure surface of the pressure plate applies pressure to the second cell surface of the pouch cell battery, and a terminal connector system configured to connect to terminals of the held pouch cell battery, the terminal connector system configured to connect with a battery cycler system.

### RELATED APPLICATION

This application claims priority to U.S. provisional patent application No. 63/700,245 filed Sep. 27, 2024 and titled “Pouch Cell Battery Compression Ampoule for a calorimeter,” the contents of which are incorporated by reference in their entirety.

### FIELD OF THE INVENTION

The disclosed technology generally relates to calorimeters. More particularly, the technology relates to testing pouch-cell batteries in calorimeters.

### BACKGROUND

The thermal analysis of battery cell electrochemistry is a major aspect of battery development. Understanding thermal information from thermal analysis information helps researchers to improve battery design. Microcalorimeters are capable of performing highly precise thermal analysis on various types of battery cells.

The most effective method for this type of thermal analysis requires highly sensitive microcalorimeters that can measure heat flow on the microwatt scale. This method uses a lifting tool to drop the battery into a test chamber of the microcalorimeter and hold the battery inside the chamber while connecting the battery to a battery cycler system located outside the microcalorimeter. The microcalorimeter then measures heat flow while the battery cycler system charges and discharges the battery. A microcalorimeter machine may be configured to operate with various lifting tools that allow researchers to test various battery types.

Some battery types must be compressed to run properly. For example, hand-made pouch cell batteries such as lithium-ion batteries, lithium metal batteries, and solid-state batteries may require compression to run properly. Researchers have test fixtures that can compress these pouch cell batteries to run tests with the battery cycler only. However, these known test fixtures are bulky and make it impossible to test these batteries within these test fixtures from within a test chamber of a microcalorimeter.

Therefore, devices and methods for applying compression to a pouch cell battery while the battery is retained within a test chamber of a calorimeter would be well received in the art.

### SUMMARY

In one aspect, a pouch cell battery lifting tool includes a base including a first pressure surface; a pressure plate including a second pressure surface, the pressure plate attachable to the base such that the first pressure surface of the base and the second pressure surface of the pressure plate define a space between which a pouch cell battery having a first cell surface and an opposing second cell surface is configured be held such that a first pressure surface of the base applies pressure to the first cell surface of the pouch cell battery and the second pressure surface of the pressure plate applies pressure to the second cell surface of the pouch cell battery; and a terminal connector system configured to connect to terminals of the held pouch cell battery, the terminal connector system configured to connect with a battery cycler system. The pouch cell battery lifting tool is adapted for holding the held pouch cell battery within a calorimeter.

Additionally or alternatively, the pouch cell battery lifting tool further includes a force sensor configured to sense a current force applied on the held pouch cell battery by the base and the pressure plate. In various embodiments, the force sensor may be a pressure mapping sensor and/or a real time pressure sensor that is connectable to a control system of a calorimeter when the pouch cell battery lifting tool is located within a calorimeter.

Additionally or alternatively, the pouch cell battery lifting tool further includes a spring loaded constant pressure attachment mechanism for attaching the pressure plate with the base, wherein the spring loaded constant pressure attachment mechanism is configured to provide constant pressure on the held pouch cell battery located between the base and the pressure plate during dimensional expansion or contraction of the held pouch cell battery. The spring loaded constant pressure attachment mechanism may include a plurality of Belleville spring washers.

Additionally or alternatively, the pouch cell battery lifting tool further includes a constant gap thickness attachment mechanism for attaching the pressure plate with the base, the constant gap thickness attachment mechanism configured to provide a constant gap between the base and the pressure plate that does not change in response to a change in dimensions of the held pouch cell battery. The constant gap thickness attachment mechanism may include an adjustable set screw.

Additionally or alternatively, the base and the pressure plate include a thickness that is optimized to provide necessary strength to enable to support pressures of at least 0.5 megapascal (MPa) while minimizing mass.

Additionally or alternatively, the pouch cell battery lifting tool further includes a thermal distribution body attached to at least one of the base and the pressure plate.

In another aspect, a calorimeter system includes a calorimeter including at least one thermal chamber, the calorimeter including a control system configured to monitor thermal activity in real time within the at least one thermal chamber. The calorimeter system further includes a pouch cell battery lifting tool that includes a base including a first pressure surface; a pressure plate including a second pressure surface, the pressure plate attachable to the base such that the first pressure surface of the base and the second pressure surface of the pressure plate define a space between which a pouch cell battery having a first cell surface and an opposing second cell surface is configured be held such that a first pressure surface of the base applies pressure to the first cell surface of the pouch cell battery and the second pressure surface of the pressure plate applies pressure to the second cell surface of the pouch cell battery; and a terminal connector system configured to connect to terminals of the held pouch cell battery, the terminal connector system configured to connect with a battery cycler system. The pouch cell battery lifting tool is adapted for holding the held pouch cell battery within a calorimeter.

In another aspect, a method of compressing a pouch cell battery while performing testing within a calorimeter system includes: providing the calorimeter system including at least one thermal chamber; providing the pouch cell battery lifting tool holding a pouch cell battery having a first cell surface and an opposing second cell surface; inserting the pouch cell battery lifting tool holding the pouch cell battery into the at least one thermal chamber of the calorimeter; applying a pressure to the first cell surface and the second cell surface of the pouch cell battery, by the pouch cell battery lifting tool; and performing thermal testing, by the calorimeter system, on the pouch cell battery within the inserted pouch cell battery lifting tool, during the applying of the pressure.

Additionally or alternatively, the applying a pressure to the first cell surface and the second cell surface of the pouch cell battery, by the pouch cell battery lifting tool includes: applying the pressure to the first cell surface with a first pressure surface of a base of the pouch cell battery lifting tool; and applying the pressure to the second cell surface with a second pressure surface of a pressure plate of the pouch cell battery lifting tool.

Additionally or alternatively, the method further includes maintaining a constant gap thickness on the held pouch cell battery between the first pressure surface and the second pressure surface during the performing the thermal testing.

Additionally or alternatively, the method further includes sensing a current pressure applied on the held pouch cell battery with a pressure plate located within the pouch cell battery lifting tool.

Additionally or alternatively, the sensing the current pressure applied on the held pouch cell battery with the pressure plate within the pouch cell battery lifting tool is during the performing the thermal testing.

Additionally or alternatively, the method further includes connecting a sensed output of the pressure plate to a control system of the calorimeter system during the performing the thermal testing.

Additionally or alternatively, the method further includes connecting terminals of the held pouch cell battery with a terminal connector system located within the pouch cell battery lifting tool.

Additionally or alternatively, the method further includes connecting the terminal connector system with a battery cycler system; and cycling the pouch cell battery with the battery cycler system during the performing the thermal testing.

Additionally or alternatively, the method further includes maintaining a constant pressure on the held pouch cell battery by the pouch cell battery lifting tool during the performing the thermal testing.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts an exploded view of a calorimeter system, in accordance with one embodiment.

FIG. 2 depicts an exploded view of a pouch cell battery lifting tool, in accordance with one embodiment.

FIG. 3 depicts an exploded cutaway view of the pouch cell battery lifting tool of FIG. 2, in accordance with one embodiment.

FIG. 4 depicts a front view of the pouch cell battery lifting tool of FIGS. 2-3, in accordance with one embodiment.

FIG. 5 depicts a rear view of the pouch cell battery lifting tool of FIGS. 2-4, in accordance with one embodiment.

FIG. 6 depicts an exploded view of another pouch cell battery lifting tool, in accordance with one embodiment.

FIG. 7A depicts a front view of the pouch cell battery lifting tool of FIG. 6, in accordance with one embodiment.

FIG. 7B depicts a rear view of the pouch cell battery lifting tool of FIGS. 6-7A, in accordance with one embodiment.

FIG. 8 depicts a cross-sectional view of the pouch cell battery lifting tool of FIGS. 6-7B, in accordance with one embodiment.

FIG. 9 depicts a method of compressing a pouch cell battery while performing testing within a calorimeter system, according to one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, the present disclosure seeks to allow researchers to test pouch-cell batteries during calorimeter testing that requires compression during the testing. In particular, aspects of the present disclosure contemplate a battery lifter tool or mechanism configured for lifting and/or lowering a pouch cell battery into a compartment or thermal chamber of a calorimeter. The battery lifter tool or mechanism is configured to apply force and/or pressure to each surface of the pouch cell battery, while allowing thermal testing to also be conducted within the calorimeter. Various systems and methods contemplated herein further enable this testing and pressure application during battery cycling tests. Thus, the systems herein enable wired connection between the pouch cell battery (located within the lifter which is in turn located within a calorimeter) to be operably connected to a battery cycler system. Still further, it is contemplated that the systems and methods herein may integrate real time pressure sensing/mapping into the lifter for researchers to monitor battery expansion or pressure points while charging and discharging.

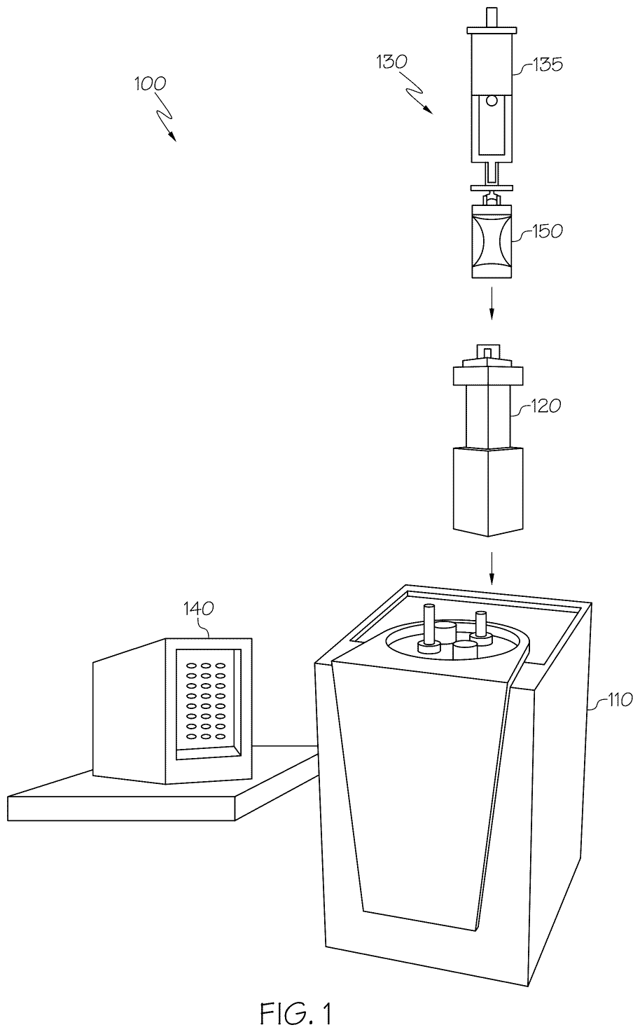

FIG. 1 depicts an exploded view of a calorimeter system 100, in accordance with one embodiment. The calorimeter system 100 includes a microcalorimetry thermal chamber system 110, a calorimeter 120, a lifting tool 130, and a battery cycler 140.

The microcalorimetry thermal chamber system 110 may be a temperature control system configured to efficiently and accurately control a set temperature for the thermostat with its own control system configured to set and maintain precise and stable temperatures. The microcalorimetry thermal chamber system 110 may provide for a wide range of calorimeter configurations and sample handling systems. The microcalorimetry thermal chamber system 110 may be modular in that the system may be configured to receive anywhere between 1 or many (e.g. 24, 48, or more) microcalorimeters therewithin, each configured to operate simultaneously and/or independently. Further, the calorimeters may be provided at various calorimeter positions within the thermal chamber. The microcalorimetry thermal chamber system 110 may further provide for interfacing a plurality of independent probes/sources, such as a pH probe or light source. The microcalorimetry thermal chamber system 110 may provide for a liquid bath system (e.g., oil-based) as a continuously circulated heat sink medium that prevents thermal events outside the chamber from altering the constant temperature within the microcalorimeters within the chamber. The microcalorimetry thermal chamber system 110 may provide for various temperature control features, such as isothermal temperature control, step isothermal temperature control, scanning temperature control, or the like. In one contemplated embodiment, the microcalorimeter thermal chamber system 110 may be the TAM IV system, offered by TA Instruments®, a subsidiary of Waters TM Corporation.

The calorimeter 120 may include at least one thermal chamber, as well as a control system configured to monitor thermal activity in real time within the at least one thermal chamber. The calorimeter 120 may be any appropriate calorimeter system, including a microcalorimeter system, a nanocalorimeter system, a multicalorimeter system, or a minicalorimeter system, for example. In one example, a twin type microcalorimeter is contemplated in which experiments may be conducted under passive storage conditions, or in conjunction with an external battery cycler to evaluate battery charging and discharging dynamics. In one contemplated embodiment, the calorimeter 120 may be the Micro XL calorimeter, offered by TA Instruments®, a subsidiary of Waters TM Corporation. Whatever the embodiment, the calorimeter 120 may be inserted, placed or otherwise lifted or lowered into the microcalorimetry thermal chamber system 110.

The lifting tool 130 may be any type of tool used to raise and/or lower a pouch cell battery into the calorimeter 120 for testing. The lifting tool 130 may take various structural forms, as shown and described herein below. For example, the lifting tool 130 may include an upper portion 135 attachable to a lower portion 150. The upper portion 135 may be configured to be held and inserted into the calorimeter 120, while the lower portion 150 may be configured to hold and connect to a pouch cell battery for testing. The lifting tool 130 may provide for connecting the pouch cell battery and/or any electronic systems or sensors of the lifting tool 130 to the control or computer system of the calorimeter 120 and/or the microcalorimetry thermal chamber system 110 in order to provide testing data thereto. While various embodiments of lifting tools are contemplated, it is contemplated that the lifting tools described herein below may be configured to hold a pouch cell battery undergoing testing within the calorimeter system 100, and further apply force or pressure to the held pouch cell battery during the testing.

The battery cycler 140 may be any appropriate system configured for running and monitoring battery cycling experiments on pouch cell batteries. The battery cycler 140 may be configured to be connected to the lifting tool 130 during insertion of the lifting tool 130 into the calorimeter 120 and further into the microcalorimetry thermal chamber system 110. The battery cycler 140 may include its own independent control system, user interface and processor system for outputting test results related to battery cycling tests.

The microcalorimetry thermal chamber system 110 and/or the calorimeter 120 and/or the lifter tool 130 may be connectable to any other computer system (not shown) for outputting or otherwise exporting test result data to a computerized software testing system. Likewise, the battery cycler 140 may be connectable to a computer system (which may be the same or a different computer system than what is connected to the other testing systems 110, 120, 130) for outputting or otherwise exporting test result data to a computerized software testing system.

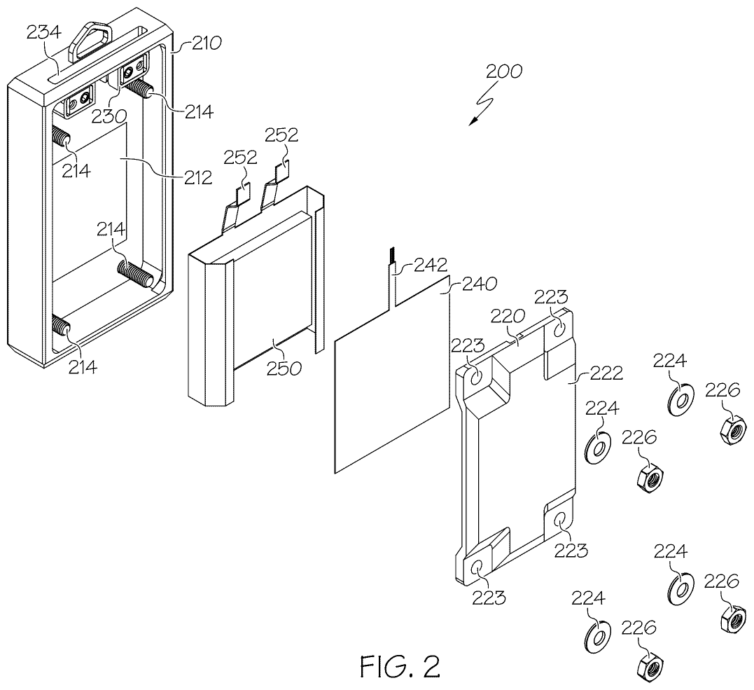

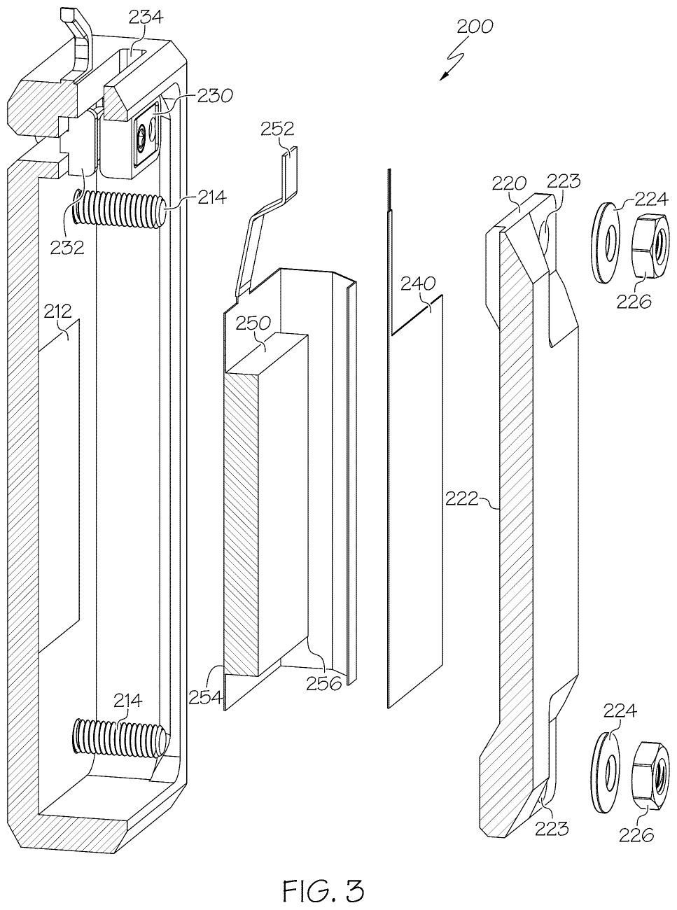

FIG. 2 depicts an exploded view of a pouch cell battery lifting tool 200, in accordance with one embodiment. Similarly, FIG. 3 depicts an exploded cutaway view of the pouch cell battery lifting tool 200 of FIG. 2, in accordance with one embodiment. The pouch cell battery lifting tool 200 includes a base 210, a pressure plate 220, a terminal connector system 230, and a force sensor 240. A pouch cell battery 250 is shown located between the base 210 and the pressure plate 220 and force sensor 240. The pouch cell battery lifting tool 200 may be configured to hold and apply pressure to any type of pouch cell battery that fits the dimensional requirements of the embodiment, such as lithium-ion batteries, lithium metal batteries, and even solid-state pouch cell batteries.

The base 210 includes a first pressure surface 212 having a thickness which may be optimized to provide the necessary strength for compression, force and/or pressure, while minimizing mass to reduce the impact of the pouch cell battery lifting tool 200 on thermal measurements within a calorimeter. For example, the first pressure surface 212 may be made of aluminum or an aluminium alloy. In one embodiment, the first pressure surface 212 may be made of a 6061 aluminium alloy. Whatever the embodiment, the base 210 and the first pressure surface 212 should use as little material as possible so that it does not impact the heat signal within the calorimeter, but enough material to apply proper compression. The base 210 may be made of two different materials, with the first pressure surface 212 being made of a stronger and more robust material while the portion of the base 210 surrounding the first pressure surface 212 may be made of a different lighter material. In still other embodiments, the entirety of the base 210 may be made of the same material.

As shown, the base 210 further includes generally rectangular shape, having bolts 214 attached to each corner within the base 210 extending upward toward the pressure plate 220 for attachment of the pressure plate 220. Such a bolted design may be utilized in order to attach the pressure plate 220 at various levels of pressure and/or force to the held pouch cell battery depending on the tightness of the attachment.

The base 210 further includes the terminal connector system 230. The terminal connector system 230 may be configured to connect to terminals 252 of the pouch cell battery 250. Further, the terminal connector system 230 may be configured to connect the pouch cell battery lifting tool 200 to a battery cycler system, such as the battery cycler system 140 shown in FIG. 1. As shown in FIG. 3, the terminal connector system 230 includes an electrical connector slot system 232 configured to receive the terminals 252 of the pouch cell battery 250. In the embodiment shown, the electrical connector slot system 232 includes two connector slots, each for receiving one of the terminals 252 of the pouch cell battery 250. An opposing side of the electrical connector slot system 232 includes an opening 234 configured to receive a wire connector of a wire system (not shown) configured to connect to a battery cycler, such as the battery cycler 140 and/or to connect to a control system of a microcalorimetry thermal chamber system such as the microcalorimetry thermal chamber system 110 and/or any computerized control interface thereof.

The pressure plate 220 includes a second pressure surface 222 configured to apply pressure to an opposing side of the held pouch cell battery 250 than the first pressure surface 212. The pressure plate 220 is thus attachable to the base 210 such that the first pressure surface 212 of the base 210 and the second pressure surface 222 of the pressure plate 220 define a space between which the pouch cell battery 250 is configured to be held such that the first pressure surface 212 of the base 210 applies pressure to a first cell surface 254 of the pouch cell battery 250 and the second pressure surface 222 of the pressure plate 220 applies pressure to a second cell surface 256 of the pouch cell battery 250.

The pressure plate 220 may include a thickness which may be optimized to provide the necessary strength for compression, force and/or pressure, while minimizing mass to reduce the impact of the pouch cell battery lifting tool 200 on thermal measurements within a calorimeter. The pressure plate 220 may also be rectangular in shape and may include a ramped outer edge extending into a flat basin within which the second pressure surface 222 resides. The second pressure surface 222 may be made of aluminum or an aluminium alloy. In one embodiment, the second pressure surface 222 may be made of a 7075 aluminium alloy. Whatever the embodiment, the pressure plate 220 and the second pressure surface 222 should use as little material as possible so that it does not impact the heat signal within the calorimeter, but enough material to apply proper compression. In the embodiment shown, the pressure plate 220 may be made of a single metallic material. In still other embodiments, the pressure plate 220 may be made of multiple materials, like the base 210.

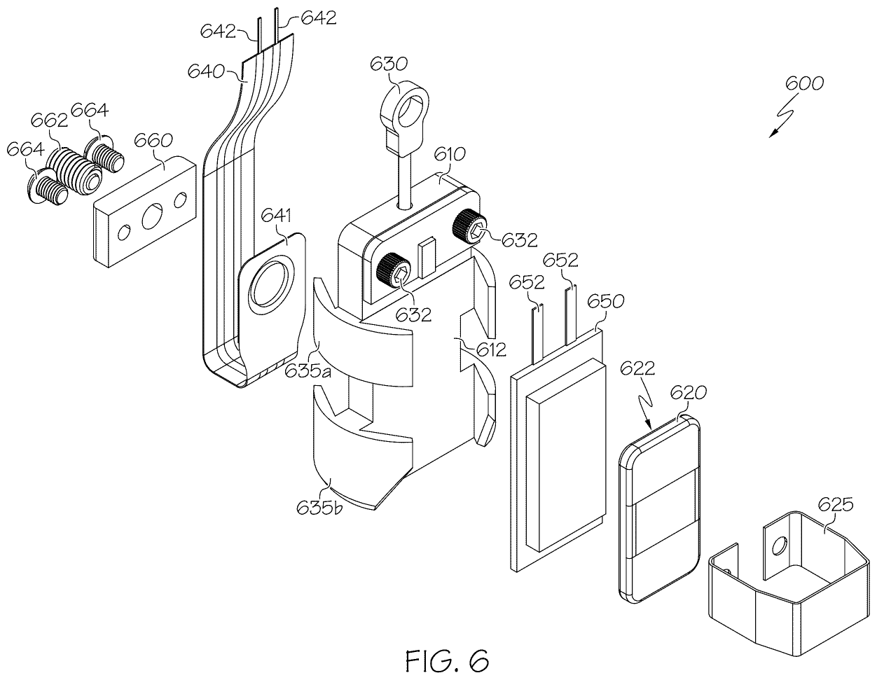

The pressure plate 220 may include four openings or through holes 213 within which the four bolts 214 of the base 210 are configured to extend when the pressure plate 220 is attached to the base 210. As shown, a plurality of Belleville spring washers 224 with nuts 226 are shown for attaching with the bolts 214 in order to attach the pressure plate 220 to the base 210. The Belleville spring washers 224, nuts 226 and bolts 214 combination may provide for a spring loaded constant pressure attachment mechanism for attaching the pressure plate with the base. Such a configuration may provide constant pressure on the held pouch cell battery 250 located between the base 210 and the pressure plate 220 during dimensional expansion or contraction of the held pouch cell battery 250. Various other embodiments are contemplated for applying pressure. One such embodiment is described herein below with respect to FIGS. 6-8.

The base 210 and the pressure plate 220 include a thickness that is optimized to provide necessary strength to enable to support pressures of at least 2 megapascal (MPa) while minimizing mass. For example, the base 210 and the pressure plate 220 include a thickness that is optimized to provide necessary strength to enable to support pressures of 2, 2.5, 3, 4, or even 5 or more megapascal (MPa) while minimizing mass.

As shown, the force sensor 240 is located between the pressure plate 220 and the held pouch cell battery 250. However, the force sensor 240 may be located between the base 210 (i.e. the first pressure surface 212 thereof) and the pouch cell battery 250. The force sensor 240 may be placed in any position whereby the force sensor may measure the force being applied to the battery. Whatever the location, the force sensor 240 may be configured to sense a current force applied on the held pouch cell battery 250 by the base 210 and the pressure plate 220. The force sensor 240 may be a single point force sensor, a pressure mapping sensor, or the like. In some embodiments, the pressure sensor may be a real time pressure sensor that is connectable to a control system of a calorimeter system (e.g., the calorimetry thermal chamber system 110 of FIG. 1, or an external computer system configured to receive test data) when the pouch cell battery lifting tool 200 is located within a calorimeter such as the calorimeter 120. In other embodiments, rather than real time measurement, the pressure sensor may require a user to measure the compression force before the pouch cell battery lifting tool 200 is placed within a calorimeter system. Whatever the embodiment, the force sensor 240 may include an electrical output 242 configured to provide force or pressure measurement information to an external device configured to convert and/or display this information to an operator.

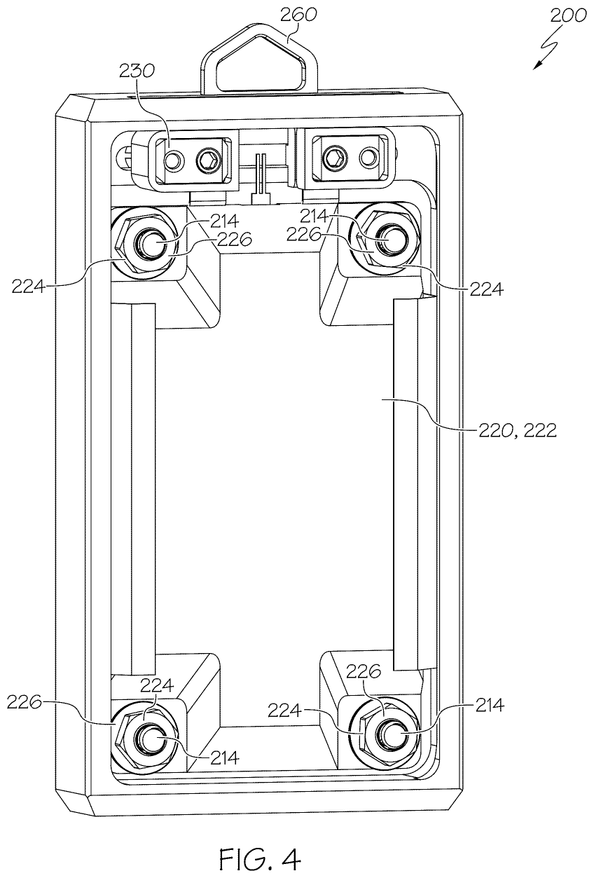

FIG. 4 depicts a front view of the pouch cell battery lifting tool 200 of FIGS. 2-3, in accordance with one embodiment. As shown, the pouch cell battery lifting tool 200 is assembled state whereby the pouch cell battery 250 is located within the pouch cell battery lifting tool 200 and the pressure plate 220 has been tightened to the base 210 with the bolts 214 and nut 226 to an appropriate pressure amount. The pouch cell battery lifting tool 200 further includes a loop mechanism 260 configured for attachment to an upper portion of a lifting tool, such as the upper portion 135 shown in FIG. 1.

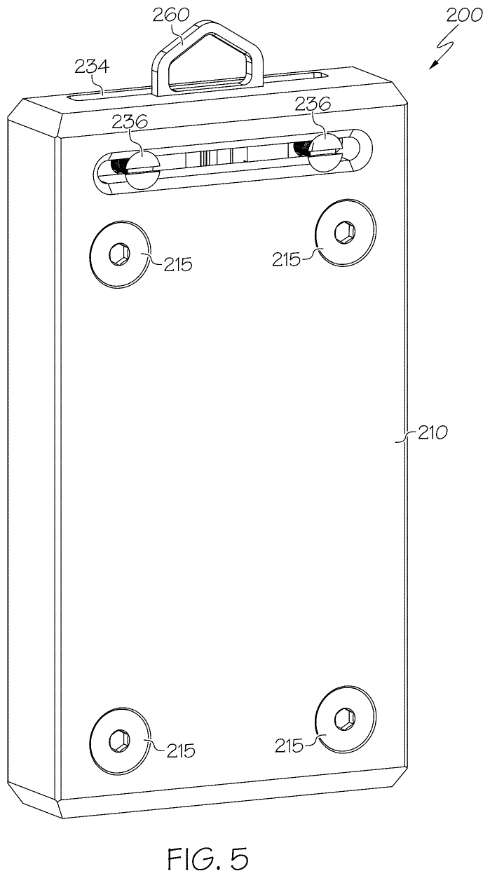

FIG. 5 depicts a rear view of the pouch cell battery lifting tool 200 of FIGS. 2-4, in accordance with one embodiment. The back side of the base 210 is shown, including four bolt heads 215 of the bolts 214 fixed into the base 210. Further, the pouch cell battery lifting tool includes two additional bolts 236 for attaching the terminal connector system 230 to the base 210 of the pouch cell battery lifting tool 200.

FIG. 6 depicts an exploded view of another pouch cell battery lifting tool 600, in accordance with one embodiment. The pouch cell battery lifting tool 600 includes a base 610, a pressure plate 620, a terminal connector system 630, and a force sensor 640. A pouch cell battery 650 is shown located between the base 610 and the pressure plate 620. Like the pouch cell battery lifting tool 200, the pouch cell battery lifting tool 600 may be configured to hold and apply pressure to any type of pouch cell battery, such as lithium-ion batteries, lithium metal batteries, and even solid-state pouch cell batteries.

The base 610 includes a first pressure surface 612 having a thickness which may be optimized to provide the necessary strength for compression, force and/or pressure, while minimizing mass to reduce the impact of the pouch cell battery lifting tool 600 on thermal measurements within a calorimeter. For example, the first pressure surface 612 may be made of aluminum or an aluminium alloy. In one embodiment, the first pressure surface 612 may be made of a 6061 aluminium alloy. Whatever the embodiment, the base 610 and the first pressure surface 612 should use as little material as possible so that it does not impact the heat signal within the calorimeter, but enough material to apply proper compression. In the embodiment shown, the base 610 may be made of two different materials, with the first pressure surface 612 being made of a stronger and more robust material while the portion 632 of the base 610 located above the first pressure surface 612 may be made of a different lighter material. In still other embodiments, the entirety of the base 610 may be made of the same material.

As shown, the base 610 further includes generally rectangular shape having additional top and bottom wings 635a, 635b. The wings 635a, 635b may be configured to optimize conduction of heat from the pouch cell battery 650 held by the pouch cell battery lifting tool 600 into the calorimeter chamber. In other embodiments, the wings 635a, 635b may be any thermal distribution body attached to at least one of the base and the pressure plate, having any shape configured to optimize thermal distribution from the pouch cell battery 650 held by the pouch cell battery lifting tool 600 into the calorimeter chamber.

The base 610 further includes the terminal connector system 630. The terminal connector system 630 may be configured to connect to terminals 652 of the pouch cell battery 650. Further, the terminal connector system 630 may be configured to connect the pouch cell battery lifting tool 600 to a battery cycler system, such as the battery cycler system 140 shown in FIG. 1. The terminal connector system 630 may further be configured to receive a wire connector of a wire system (not shown) configured to connect to a battery cycler, such as the battery cycler 140 and/or to connect to a control system of a microcalorimetry thermal chamber system such as the microcalorimetry thermal chamber system 110 and/or any computerized control interface thereof.

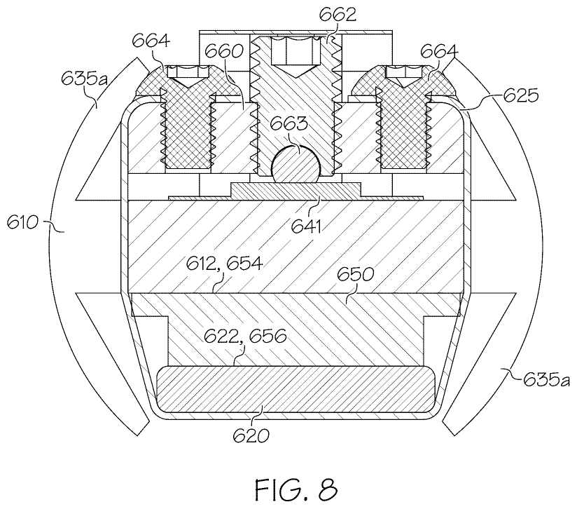

The pressure plate 620 includes a second pressure surface 622 configured to apply pressure to an opposing side of the held pouch cell battery 650 than the first pressure surface 612. The pressure plate 620 is thus attachable to the base 610 such that the first pressure surface 612 of the base 610 and the second pressure surface 622 of the pressure plate 620 define a space between which the pouch cell battery 650 is configured to be held such that the first pressure surface 612 of the base 610 applies pressure to a first cell surface 654 of the pouch cell battery 650 and the second pressure surface 622 of the pressure plate 620 applies pressure to a second cell surface 656 of the pouch cell battery 650, as shown more particularly in FIG. 8.

The pressure plate 620 may include a thickness which may be optimized to provide the necessary strength for compression, force and/or pressure, while minimizing mass to reduce the impact of the pouch cell battery lifting tool 600 on thermal measurements within a calorimeter. The pressure plate 620 may be a rectangular shaped plate. The second pressure surface 622 may be made of aluminum or an aluminium alloy. In one embodiment, the second pressure surface 622 may be made of a 7075 aluminium alloy. Whatever the embodiment, the pressure plate 620 and the second pressure surface 622 should use as little material as possible so that it does not impact the heat signal within the calorimeter, but enough material to apply proper compression. In the embodiment shown, the pressure plate 620 may be made of a single metallic material. In still other embodiments, the pressure plate 620 may be made of multiple materials, like the base 610.

The base 610 and the pressure plate 620 include a thickness that is optimized to provide necessary strength to enable to support pressures of at least 0.5 megapascal (MPa) while minimizing mass. For example, the base 610 and the pressure plate 620 include a thickness that is optimized to provide necessary strength to enable to support pressures of 2, 2.5, 3, 4, or even 5 or more megapascal (MPa) while minimizing mass.

The base 610 and the pressure plate 620 may be attached together by a strap structure 625. The strap structure 625 may be made of metal and may include at least two openings configured to receive bolts 664. A block 660 may be configured to apply pressure created by a set screw 662 onto the held pouch cell battery 650 within the pouch cell battery lifting tool 600. The at least two openings of the strap structure 625 may align with the openings within the block 660 in order to receive the bolts 664 and attach the block 660 to the strap structure 625.

As shown, the force sensor 640 is located between the block 660 and the base 610. However, in other embodiments the force sensor 640 may be located between the base 610 (i.e. the first pressure surface 612 thereof) and the pouch cell battery 650, for example. In other embodiments, the force sensor 640 may be located between the second pressure surface 622 of the pressure plate 620 and the second cell surface 656 of the pouch cell battery 650. Whatever the location, the force sensor 640 may be configured to sense a current force applied on the held pouch cell battery 650 by the base 610 and the pressure plate 620 and set screw 664 and/or block 660. The force sensor 640 may be a single point force sensor, a pressure mapping sensor, or the like. In some embodiments, the pressure sensor may a real time pressure sensor that is connectable to a control system of a calorimeter system (e.g., the calorimetry thermal chamber system 110 of FIG. 1, or an external computer system configured to receive test data) when the pouch cell battery lifting tool 600 is located within a calorimeter such as the calorimeter 120. In other embodiments, rather than real time measurement, the pressure sensor may require a user to measure the compression force before the pouch cell battery lifting tool 200 is placed within a calorimeter system. Whatever the embodiment, the force sensor 640 may include an electrical output 642 configured to provide force or pressure measurement information to an external device configured to convert and/or display this information to an operator.

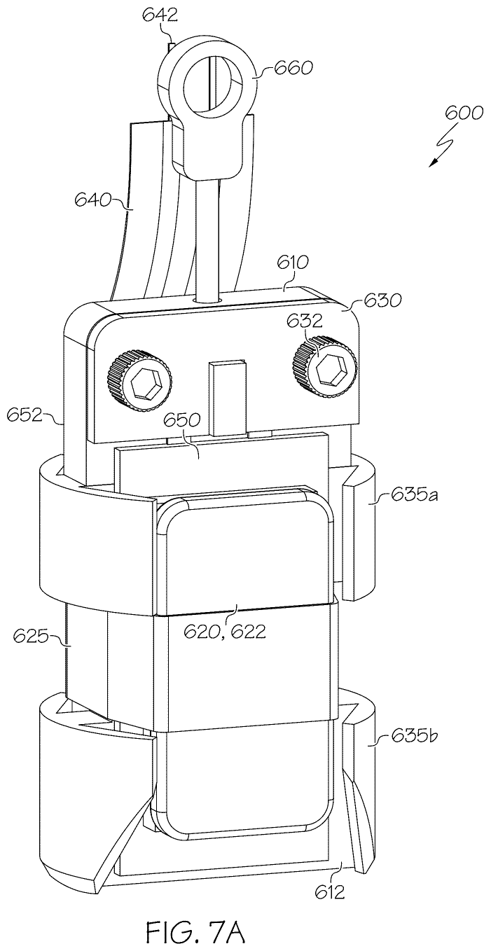

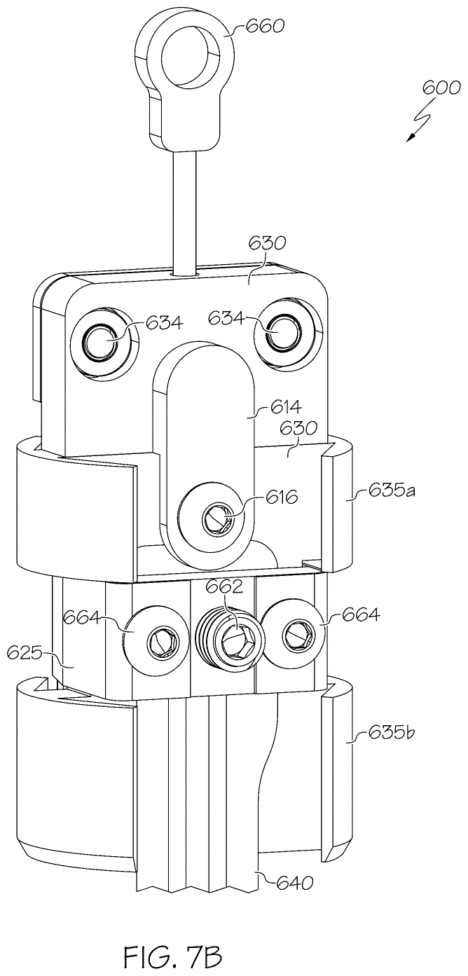

FIG. 7A depicts a front view of the pouch cell battery lifting tool 600 of FIG. 6, in accordance with one embodiment. As shown, the strap structure 625 has attached the base 610 with the pressure plate 620 in order to put the pouch cell battery 650 under pressure within the pouch cell battery lifting tool 600. Moreover, the pouch cell battery lifting tool 600 includes two bolts 632 for attaching the terminal connector system 630 to the top of the base 610. Further, the terminals 652 of the pouch cell battery 650 are shown in inserted into the terminal connector system 630. The pouch cell battery lifting tool 600 further includes a loop mechanism 660 configured for attachment to an upper portion of a lifting tool, such as the upper portion 135 shown in FIG. 1.

FIG. 7B depicts a rear view of the pouch cell battery lifting tool 600 of FIGS. 6-7A, in accordance with one embodiment. As shown, during the assembled state, the bolts 664 and the set screw 622 are accessible. The bolts 664 have attached the block 660 to the base 610. Further, as shown from the rear view, the upper portion of the base 610 includes a tab 614 for connecting the upper portion of the base 610 to the main portion and/or the pressure surface 612 of the base 610 through a bolt 616. Moreover, the terminal connector system 630 is shown connected to the upper portion of the base 610 through bolts 634.

FIG. 8 depicts a cross-sectional view of the pouch cell battery lifting tool 600 of FIGS. 6-7B, in accordance with one embodiment. The pouch cell battery lifting tool 600 includes a constant gap thickness attachment mechanism for attaching the pressure plate 620 with the base 610. Unlike the pouch cell battery lifting tool 200 described above, the pouch cell battery lifting tool 610 applies a pressure without providing for any spring mechanism to adjust the size of the gap based on changes in battery dimensions during testing (e.g., due to the chemistry in the battery during battery cycling). The constant gap thickness attachment mechanism may be the set screw 662 having a ball 663 with a flat surface configured to provide a constant gap between the base 610 and the pressure plate 62—that dose not change in response to a change in dimensions of the held pouch cell battery 650. As shown, when the set screw 662 is tightened, the flat surface of the ball 663 is configured to provide pressure to a force receiving portion 641 of the force sensor 640. This pressure is then transferred through the body of the base 610 and into the first pressure surface 612 of the base 610. The pressure plate 620 is thus attachable to the base 610 such that the first pressure surface 612 of the base 610 and the second pressure surface 622 of the pressure plate 620 define a space between which the pouch cell battery 650 is configured to be held such that the first pressure surface 612 of the base 610 applies pressure to a first cell surface 654 of the pouch cell battery 650 and the second pressure surface 622 of the pressure plate 620 applies pressure to a second cell surface 656 of the pouch cell battery 650.

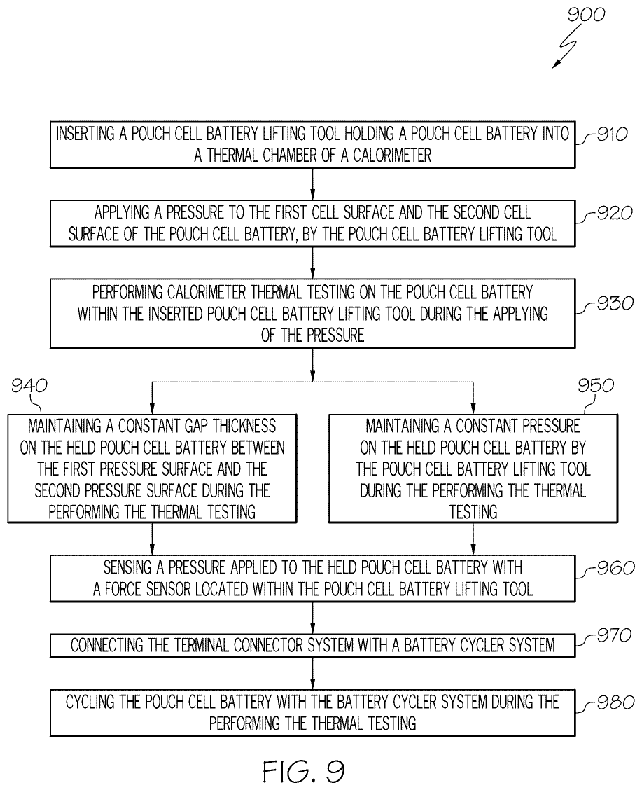

FIG. 9 depicts a method 900 of compressing a pouch cell battery, such as one of the pouch cell batteries 200, 600 while performing testing within a calorimeter system, such as the system 100, according to one embodiment. The method 900 may include providing a calorimeter system including a thermal chamber, such as the system 100 and/or one or more of the components thereof. The method 900 providing a pouch cell battery lifting tool, such as one of the pouch cell battery lifting tools 200, 600, holding a pouch cell battery having a first cell surface and an opposing second cell surface.

The method 900 includes a first step 910 of inserting the pouch cell battery lifting tool holding the pouch cell battery into the at least one thermal chamber of the microcalorimeter. The method 900 further includes a step 920 of applying a pressure to the first cell surface and the second cell surface of the pouch cell battery by the pouch cell battery lifting tool. For example, the step 920 may include both applying the pressure to the first cell surface with a first pressure surface of a base, such as the base 210, 610, of the pouch cell battery lifting tool and/or applying the pressure to the second cell surface with a second pressure surface of a pressure plate, such as the pressure plate 220, 620, of the pouch cell battery lifting tool.

Still further, the method 900 includes a step 930 of performing thermal testing, by the calorimeter system, on the pouch cell battery within the inserted pouch cell battery lifting tool, during the applying of the pressure. The step 930 may be accomplished by one or both of a substep 940 of maintaining a constant gap thickness on the held pouch cell battery between the first pressure surface and the second pressure surface during the performing the thermal testing such as described herein above with the pouch cell battery lifting tool 600, and/or a substep 950 of maintaining a constant pressure on the held pouch cell battery by the pouch cell battery lifting tool during the performing the thermal testing such as described herein above with the pouch cell battery lifting tool 200.

Moreover, the method 900 may include a step 960 of sensing a pressure applied on the held pouch cell battery with a force sensor located within the pouch cell battery lifting tool. In some instances, the step 960 may occur when the pouch cell battery is within the calorimeter system and occur in real time during testing. For example, the step 960 may include connecting a sensed output of the force sensor to a control system of the microcalorimeter system during the performing the thermal testing. The step 960 may include, for example, connecting terminals, such as the terminals 252, 652, of the held pouch cell battery with a terminal connector system, such as the terminal connector system 230, 630, located within the pouch cell battery lifting tool. In other instances, the step 960 may occur before the pouch cell battery and lifting tool is placed within a calorimeter system and may require the measurement of the compression force before the pouch cell battery lifting tool 200 is placed within a calorimeter system.

The method 900 may further include a step 970 of connecting the terminal connector system with a battery cycler system, such as the battery cycler 110. The method 900 may include a step 980 of cycling the pouch cell battery with the battery cycler system during the performing the thermal testing.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A pouch cell battery calorimeter lifting tool comprising:
a base including a first pressure surface;
a pressure plate including a second pressure surface, the pressure plate attachable to the base such that the first pressure surface of the base and the second pressure surface of the pressure plate define a space between which a pouch cell battery having a first cell surface and an opposing second cell surface is configured be held such that a first pressure surface of the base applies pressure to the first cell surface of the pouch cell battery and the second pressure surface of the pressure plate applies pressure to the second cell surface of the pouch cell battery; and
a terminal connector system configured to connect to terminals of the held pouch cell battery, the terminal connector system configured to connect with a battery cycler system,
wherein the pouch cell battery lifting tool is adapted for holding the held pouch cell battery within a calorimeter.

2. The pouch cell battery calorimeter lifting tool of claim 1, further comprising a force sensor configured to sense a current force applied on the held pouch cell battery by the base and the pressure plate.

3. The pouch cell battery calorimeter lifting tool of claim 2, wherein the force sensor is a pressure mapping sensor.

4. The pouch cell battery calorimeter lifting tool of claim 2, wherein the pressure sensor is a real time pressure sensor that is connectable to a control system of a calorimeter when the pouch cell battery lifting tool is located within a calorimeter.

5. The pouch cell battery calorimeter lifting tool of claim 1, further comprising:
a spring loaded constant pressure attachment mechanism for attaching the pressure plate with the base, wherein the spring loaded constant pressure attachment mechanism is configured to provide constant pressure on the held pouch cell battery located between the base and the pressure plate during dimensional expansion or contraction of the held pouch cell battery.

6. The pouch cell battery calorimeter lifting tool of claim 5, wherein the spring loaded constant pressure attachment mechanism includes a plurality of Belleville spring washers.

7. The pouch cell battery calorimeter lifting tool of claim 1, further comprising:
a constant gap thickness attachment mechanism for attaching the pressure plate with the base, the constant gap thickness attachment mechanism configured to provide a constant gap between the base and the pressure plate that dose not change in response to a change in dimensions of the held pouch cell battery.

8. The pouch cell battery calorimeter lifting tool of claim 7, wherein the constant gap thickness attachment mechanism includes an adjustable set screw.

9. The pouch cell battery calorimeter lifting tool of claim 1, wherein the base and the pressure plate include a thickness that is optimized to provide necessary strength to enable to support pressures of at least 0.5 megapascal (MPa) while minimizing mass.

10. The pouch cell battery calorimeter lifting tool of claim 1, further comprising a thermal distribution body attached to at least one of the base and the pressure plate.

11. A calorimeter system comprising:
a calorimeter including at least one thermal chamber, the calorimeter including a control system configured to monitor thermal activity in real time within the at least one thermal chamber; and
the pouch cell battery lifting tool of claim 1.

12. A method of compressing a pouch cell battery while performing testing within a calorimeter system, the method comprising:
providing the calorimeter system including at least one thermal chamber;
providing the pouch cell battery lifting tool holding a pouch cell battery having a first cell surface and an opposing second cell surface;
inserting the pouch cell battery lifting tool holding the pouch cell battery into the at least one thermal chamber of the calorimeter;
applying a pressure to the first cell surface and the second cell surface of the pouch cell battery, by the pouch cell battery lifting tool; and
performing thermal testing, by the calorimeter system, on the pouch cell battery within the inserted pouch cell battery lifting tool, during the applying of the pressure.

13. The method of claim 12, wherein the applying a pressure to the first cell surface and the second cell surface of the pouch cell battery, by the pouch cell battery lifting tool includes:
applying the pressure to the first cell surface with a first pressure surface of a base of the pouch cell battery lifting tool; and
applying the pressure to the second cell surface with a second pressure surface of a pressure plate of the pouch cell battery lifting tool.

14. The method of claim 13, further comprising:
maintaining a constant gap thickness on the held pouch cell battery between the first pressure surface and the second pressure surface during the performing the thermal testing.

15. The method of claim 12, further comprising:
sensing a current pressure applied on the held pouch cell battery with a force sensor located within the pouch cell battery lifting tool.

16. The method of claim 15, wherein the sensing the current pressure applied on the held pouch cell battery with the force sensor within the pouch cell battery lifting tool is during the performing the thermal testing.

17. The method of claim 16, further comprising:
connecting a sensed output of the force sensor to a control system of the calorimeter system during the performing the thermal testing.

18. The method of claim 12, further comprising:
connecting terminals of the held pouch cell battery with a terminal connector system located within the pouch cell battery lifting tool.

19. The method of claim 18, further comprising:
connecting the terminal connector system with a battery cycler system; and
cycling the pouch cell battery with the battery cycler system during the performing the thermal testing.

20. The method of claim 12, further comprising:
maintaining a constant pressure on the held pouch cell battery by the pouch cell battery lifting tool during the performing the thermal testing.
